(19) United States
(12) Patent Application Publication
(10) Pub. No.: US 2013/0270417 A1
(43) Pub. Date: Oct. 17, 2013

(54) Winged Holder for Television Remote Control

(71) Applicant: Dave Pemberton, Lawrenceville, GA (US)

(72) Inventor: Dave Pemberton, Lawrenceville, GA (US)

(21) Appl. No.: 13/446,645

(22) Filed: Apr. 13, 2012

(51) Int. Cl. F16M 13/00

(52) U.S. Cl. CPC F16M 13/00
USPC 248/682

(57) ABSTRACT

Disclosed is a holder for a remote control unit of the type commonly used to operate televisions, radios, stereo systems, entertainment centers, and the like. The holder is constructed with “wings” and “stabilizer” structures, orthogonally attached to each other, and with a means for attaching the holder to a remote control. The device, when attached to a remote control, functions to catch the visual attention of a person who may be engaged in searching for the temporarily misplaced remote control. The orthogonal attachment of the wings and stabilizer further serve to give the combined holder and remote control a profile that prevents embedment of the remote control between seat cushions or other crevices normally present in furniture such as couches, loveseats, and recliners. The device further provides varying means by which a user may grasp and operate the buttons and switches of the remote control.

### CROSS-REFERENCES TO RELATED APPLICATIONS

Not Applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

The inventive concept presented herein generally is concerned with devices and methods for effectively and accessibly retaining remote control devices, particularly those types that are used for remotely operating, television sets, stereo equipment, radios, and the like.

In the past two decades there has evolved a multitude of electronic home entertainment devices used in residences and commercial establishments. As a result many ingenious methods of remote control devices have been developed for user convenience in the operation of various types of equipment. The most predominant control has been the typical hand-held remote controller for programming and functioning of various attributes of a television set. Likewise, one of the most frustrating problems associated with the remote controller is its temporary misplacement by its owner or at times, guests. The controller may be in any one of dozens of locations, including between sofa cushions, under a table, an infrequently used shelf, under newspapers, and the list goes on.

It is of course desirable to provide a simple and inexpensive means of retention for a remote controller that lends itself to quick and relatively obvious discovery when the remote is searched for. The inventive concept herein presents a unique solution to this problem.

(2) Description of the Related Art

The following documents illustrate a general summary of similar devices and concepts in this held.

In U.S. Pat. No. 7,642,912, the inventor discloses an invention which includes one or more recesses for holding remote controls and one or more cup holders. The holder may also include a heating device and/or a cooling device coupled to the cup holder. The holder may also include a paging system with one or more paging buttons. Each of the paging buttons is associated with a paging receiver attached to a remote control to be stored in the recess.

A remote control holder system that includes an ornamental remote control cover that is detachably connectable to a corresponding base is shown in U.S. Pat. No. 6,769,658 (2004). The remote control cover resembles a surfboard and the base resembles a breaking wave so as to visually convey the practice of channel surfing.

U.S. Pat. No. 6,053,461 (2000) presents a stand for supporting a remote control above a floor surface so that the remote control is easily retrievable by a user. The stand includes a base with a tubular post upwardly extending from the base. The post has a top end with an opening. A first end of an elongate flexible member is extended into the post through the opening of the top such that a second end of the elongate flexible member outwardly extends from the top end of the post. A weight is disposed in the post and coupled to the first end of the elongate flexible member. The second end of the elongate flexible member is designed for attaching a remote control thereto.

In U.S. Pat. No. 5,954,208 (1999) there is shown a holder for multiple remote control units includes a plurality of generally planar ties pivotally coupled to as cylindrical support at one end. The tiers are pivotable to separate at angular positions and secured by an elongated fastener or the like. Embodiments are shown having two and three tiers. A plurality of hook and loop fabric fasteners are secured to the upper surfaces of each receiving tier and to the undersurfaces of the to-be secured remote control.

U.S. Pat. No. 5,605,312 (1997) presents embodiments of a universal holder which may be removably attached to the horizontal or nearly horizontal member of an exercise machine or similar object. A remote control may be removably attached to the top of the universal holder and held in a convenient and accessible position for use by persons using the exercise machine or similar object. A holder is also provided which may hold a beverage, cellular telephone, or similar object in a convenient and secure position.

The inventor of U.S. Pat. No. 4,991,892 (1991) designed a holder for audio and video remote controls and the like which includes a plurality of elongate support members to which at least one remote control can be attached. The elongate support members are spaced apart and attached to an integral body which forms gaps wide enough for a user's hand to grasp an individual remote control device in a normal operating manner. The attached remote control is supported in an upright position thereby and is easy to locate. The body of the remote control holder may include an orifice fix handy storage and use of literature pertaining to television programming, video tape recorder instructions, and the like.

U.S. Pat. No. 4,739,897 (1988) discloses a holder for a remote control unit comprising a floor panel disposed between and spanning a pair of spaced side panels, a front panel, and a rear panel forming therebetween a remote control unit receiving compartment to contain and position the remote control. A lower compartment is formed beneath the floor panel so that batteries for the remote control unit can be stored within. A pair of holders can be secured together in a back-to-back relationship for holding two remote control units.

### BRIEF SUMMARY OF THE INVENTIVE CONCEPT

The inventive concept herein discloses a remote control holder that is of a smaller size than the typical television remote control. The device is also equipped with “wings” and “stabilizer” structures, orthogonally attached to each other. The aeronautic-resembling device functions to catch the visual attention of a person who may be engaged in searching for a temporarily misplaced remote control, provided the remote control has been attached to the holder. Further, the wings and stabilizer are oriented orthogonally to each other so as to give the combined holder and remote control a profile that serves to prevent in-depth embedment of the remote control between seat cushions or other crevices normally present in furniture such as couches, loveseats, and recliners. The device, when combined with a remote control, further provides varying means by which a user may grasp and operate the controls of the remote control

### BRIEF DESCRIPTION OF THE VIEWS OF THE DRAWINGS

The objects, features, and advantages of the concept presented in this application are more readily understood when referring to the accompanying drawings. The drawings, totaling eighteen figures, show the basic functions of various embodiments and methods. In the several figures, like reference numbers are used in each figure to correspond to the same component as may be depicted in other figures.

FIG. 1 presents a view of the top surface of a typical television remote control as it is attached to the holder.

FIG. 2 is a view of the holder as it is attached to the bottom surface of a remote control.

FIG. 3 illustrates a side view of the remote control and the holder attached by means of a hook-and-felt type fastener.

FIG. 4 presents a front view of the con-joined remote control and holder.

FIG. 5 presents a user grasping a holder having contoured wings and operating the attached remote control, as a two-handed function.

FIG. 6 depicts the holder as attached to the bottom surface of the remote by means of a double-sided adhesive fastener.

FIG. 7 illustrates a side view of the remote control with the holder attached by means of a double-sided adhesive fastener.

FIG. 8 presents a front view of the joined remote control and holder, attached to each other by means of a double-sided adhesive fastener.

FIG. 9 presents a view of a one-handed operation of the remote control as it is attached to a holder with contoured wings.

FIG. 10 depicts a holder as attached to the bottom surface of a remote control with contoured wings.

FIG. 11 illustrates a side view of a remote controller with a contoured vertical stabilizer, further showing the holder attached by means of a hook-and-felt type fastener.

FIG. 12 is a front view of the joined remote control and holder.

FIG. 13 presents a view of a one-handed operation of a remote control attached to a holder having a vertical stabilizer attachment slot.

FIG. 14 depicts a slotted holder as attached to the bottom surface of a remote control having an attachment slot for the vertical stabilizer.

FIG. 15 illustrates a side view of a remote control and a holder having an attachment slot, further utilizing a hook-and-felt type fastener.

FIG. 16 is a front view of the illustration of FIG. 14.

FIG. 17 is a view of a holder, its fastening mechanism, and further showing an auxiliary hook-and-felt fastener for attachment to a remote control.

FIG. 18 is a view of two-component holder having an attachment box and vertical stabilizer.

Nomenclature For Invention Components

| | |
|---|---|
| 1. | Remote controller holder |
| 2. | Remote controller |
| 3. | Signal emitter |
| 4. | Top surface of remote |
| 5. | Bottom surface of remote |
| 6. | Left side of remote |
| 7. | Left wing |
| 8. | Right wing |
| 9. | Vertical stabilizer |
| 10. | Right side of remote |
| 11. | Underside of holder |
| 11(a). | Topside of holder |
| 12. | Hook component of fastening |
| | mechanism |
| 13. | Felt component of fastening |
| | mechanism |
| 14. | n/a |
| 15. | Auxiliary fastener |
| 16. | Peel-off protective backing |
| 17. | Adhesive |
| 18. | Double-sided adhesive fastener |
| 19. | Battery compartment access door |
| 20. | Contoured left wing |
| 21. | Contoured right wing |
| 22. | Contoured stabilizer |
| 23. | Attachment box |
| 24. | Flanged vertical stabilizer |
| 25. | Stabilizer base |
| 26. | Stabilizer tip |
| 27. | Flange |
| 28. | Open groove |

### DETAILED DESCRIPTION OF THE INVENTIVE CONCEPT

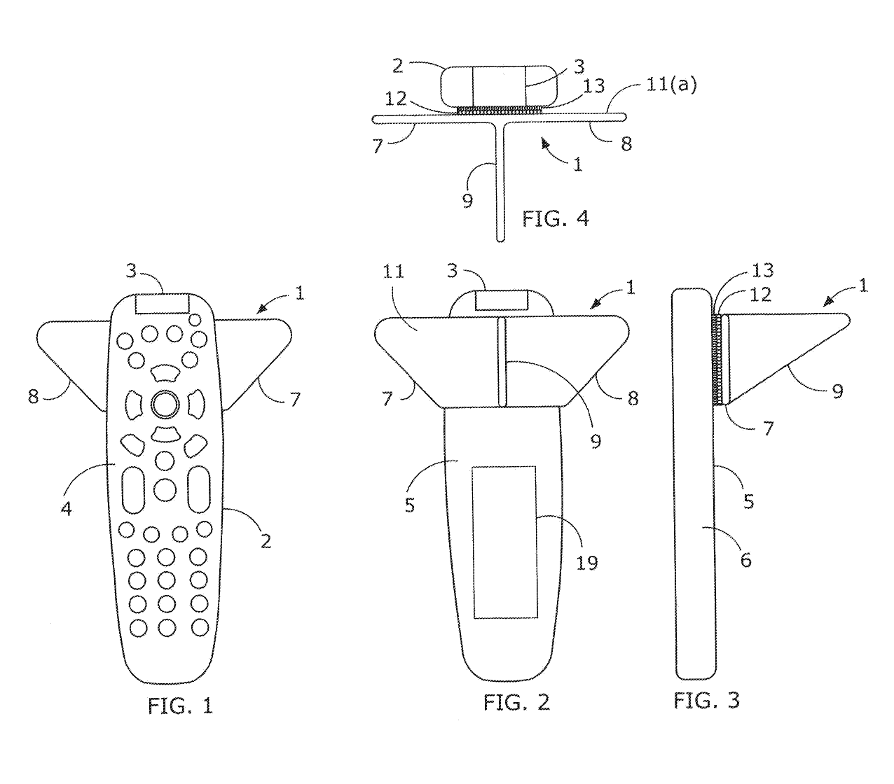

For the sake of convenience, the functional examples of the inventive concept disclosed will be made beginning with reference to FIG. 1 through FIG. 4. These drawings demonstrate four positional views of the remote control holder 1 (the “holder”) as it is attached to a typical television remote control 2. The normal control buttons and selectors are shown on the top surface 4 of the remote control 2 in FIG. 1.

FIG. 2 presents a view of the bottom surface 5 of the remote 2. A user, upon utilizing the remote control 2, will find it comfortable to grasp the vertical stabilizer 9. FIG. 3 and FIG. 4 illustrate the relative positioning of the vertical stabilizer 9, and further demonstrate the convenience of location of the vertical stabilizer 9. The two wings 7, 8, of the device serve to balance the holder 1—remote control 2 combination against the hand or fingers of a user. A typical location of a battery compartment 19 for the remote control 2 is also shown in FIG. 2.

As can be seen in FIG. 3 and in FIG. 4, the holder 1 further comprises the hook component 12 of a hook-and-felt fastening mechanism, while the remote control 2 has the felt component 13 of the hook-and-felt fastening mechanism attached to the bottom side of the remote control 2. The holder 1 and the remote control 2 may be attached to each other by any of a variety of fastening means, including, but not limited to, adhesives, magnets, inter-connected slots or grooves, screws, snaps, and so forth.

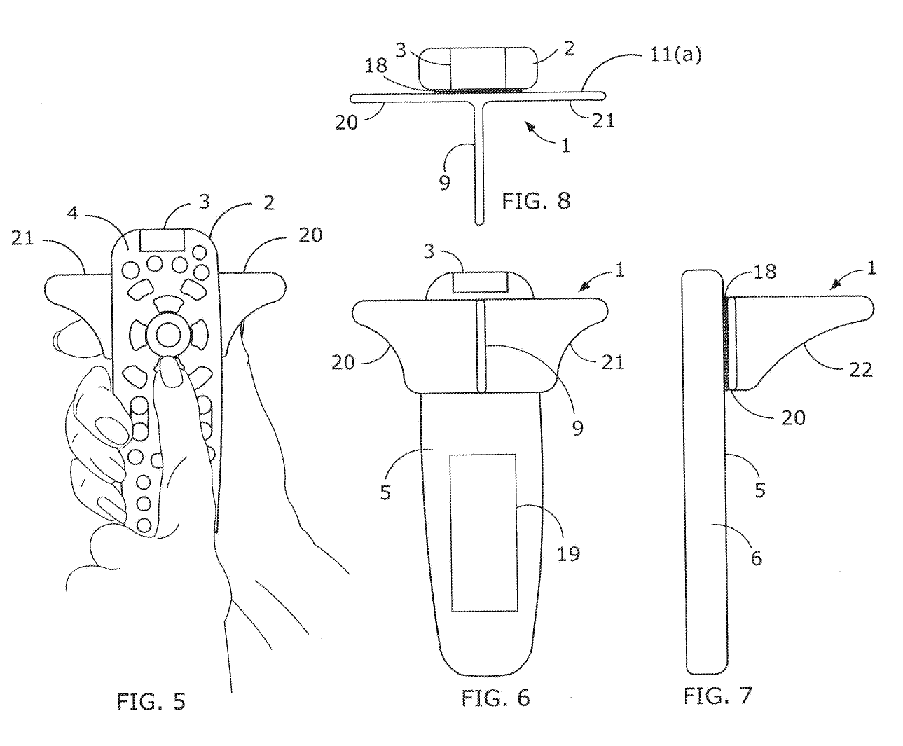

FIG. 5 illustrates a user activating the controls on the top surface 4 of a typical remote control 2 while grasping the holder 1 with one hand and actively pressing the controls with his/her free hand. The holder 1 in FIG. 5 is structured with contoured wings 20, 21 as an optional design choice for consumers. FIG. 6 through FIG. 8 again present different perspectives of the holder 1 with contoured wings 29, 21. The holder 1 and remote control 2 are also shown, in FIG. 7 and FIG. 8, to be joined directly with a double-sided adhesive fastener 18.

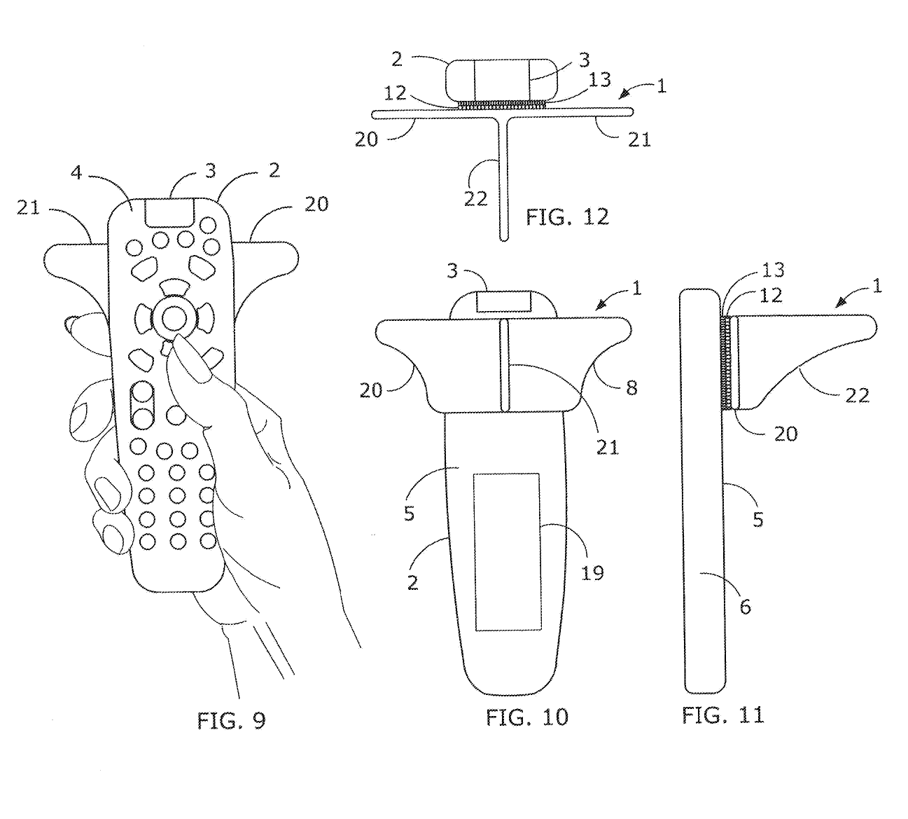

FIG. 9 through FIG. 12 present a holder 1 with contoured wings 20, 21 and also a contoured vertical stabilizer 22. FIG. 9 in particular, demonstrates a one-handed use of the remote control 2 and its attached holder 1.

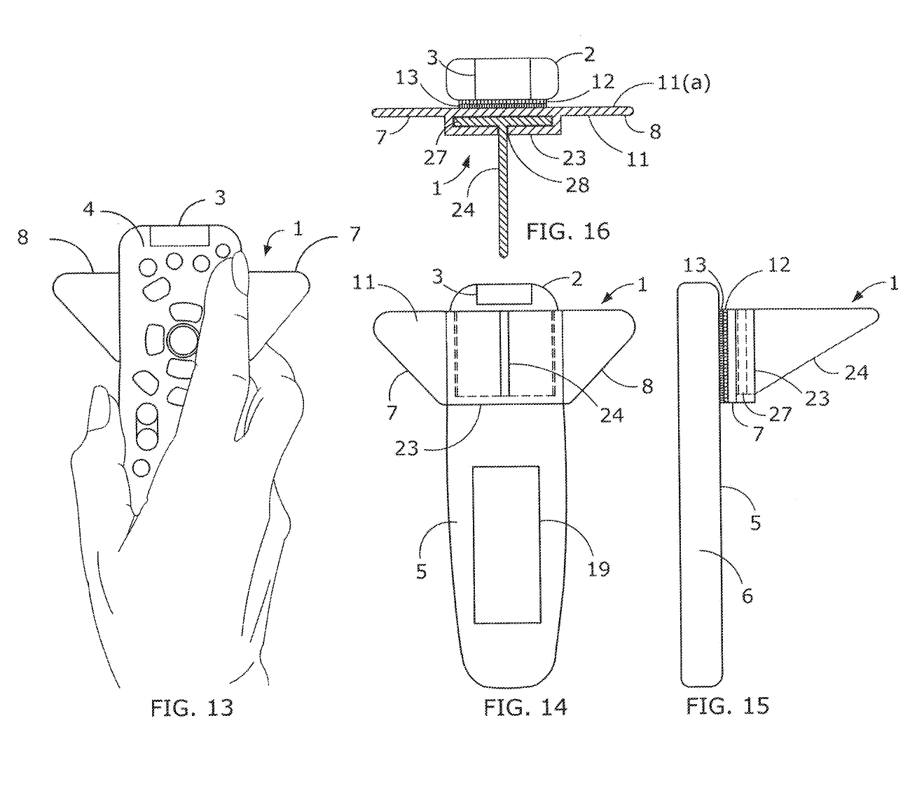

FIG. 13 through FIG. 16 illustrate an embodiment of the holder 1 having a form-fitted attachment box 23, which box 23 is affixed atop, and parallel to, the underside 11 of the device's wines 7, 8. The attachment box 23 further comprises an open groove 28, running equidistant between the ends of the wings, 7, 8. The holder 1 in this series of figures features a vertical stabilizer 24 having a base comprising an orthogonal flange 27. The flange 27 is insertable into the attachment box 23, and simultaneously into the open groove 28 of the attachment box 23.

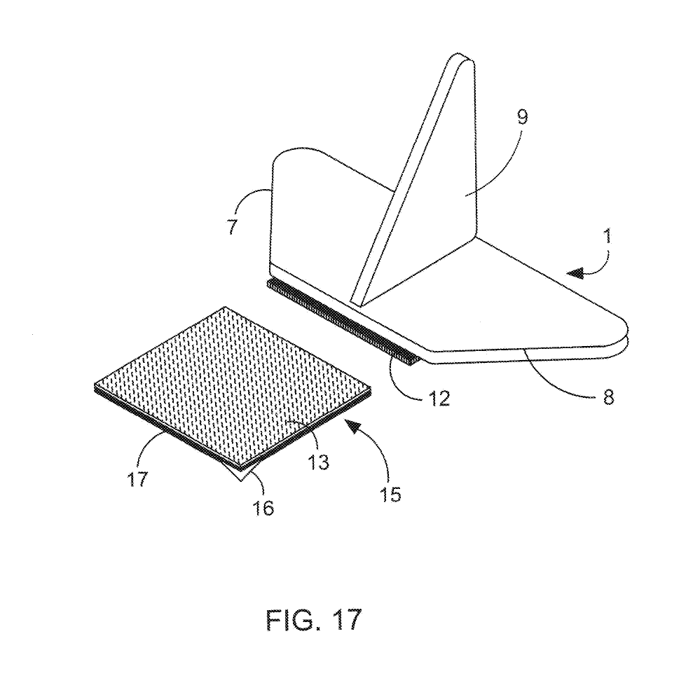

FIG. 17 demonstrates the positional relationship between the holder 1 and the auxiliary fastener 15. Upon initiating use of a holder 1 having an auxiliary fastener 15, the user must first peel off the protective backing 16, exposing the adhesive 17, and firmly press the adhesive 17 against the underside 5 of the remote control 2 to be used. The felt component 13 of the auxiliary fastener 15 is then made available for secure fastening against the hook component 12 of the hook-and-felt fastening mechanism of the holder 1.

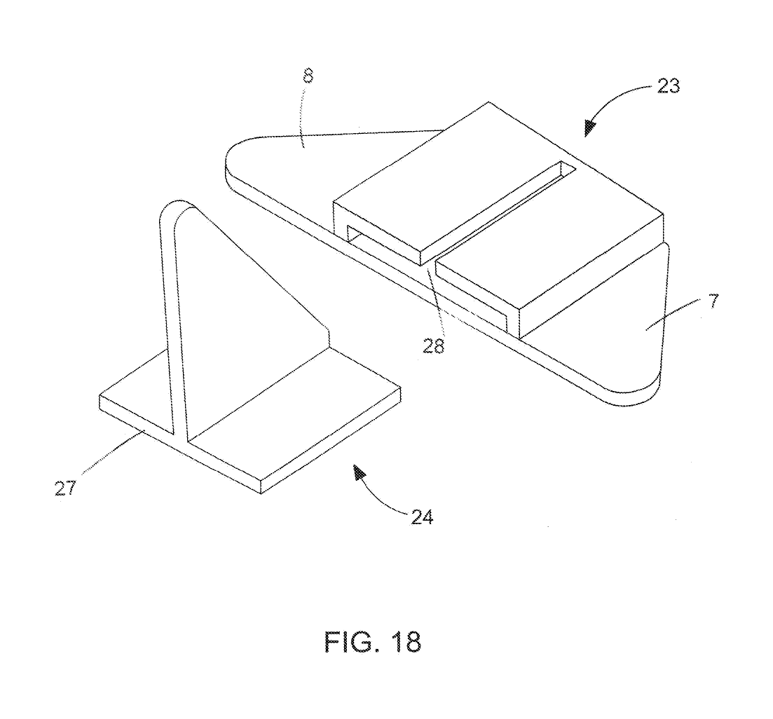

For clarity, FIG. 18 illustrates the embodiment having an attachment box 23, an open groove 28, running equidistant between the ends of the wings 7, 8. The holder features a vertical stabilizer 24 having a base comprising an orthogonal flange 27. The flange 27 is insertable into the attachment box 23, and simultaneously into the open groove 28 of the attachment box 23.

What is claimed is:

1. A single-handed holder device constructed so as to prevent engorgement of the holder between the crevices, cushions, and/or folds of flexible furniture seats when the holder is placed for use in combination with a variety of electronic remote control apparatuses of the type commonly used to remotely operate televisions, radios, stereo systems, entertainment centers, and the like, the holder comprising:
a first member, generally planar and shaped in the manner of an aircraft wing and defined by a left wing, a right wing, a top surface, and an underside;
a second member, being essentially a planar, right-triangular shape, defined as a vertical stabilizer, having a wide base and a narrower tip, wherein
the base of said second member is permanently attached perpendicularly to the underside of said first member such that the base of said second member is on a line equidistant between the left wing end and the right wing end of said first member; and
a means for attaching the bottom surface of a remote control apparatus to the top surface of said first member of said holder device; wherein
the conjoining of the first member and the second member, in combination with a remote control, form a cross-sectional profile serving to prevent the concealment of the holder device within folds, crevices, or junctions of cushions existing in furniture seats when the device is placed in the vicinity of said folds, crevices or junctions.

2. A single-handed holder device constructed so as to prevent engorgement of the holder between the crevices, cushions, and/or folds of flexible furniture seats when the holder is placed in use in combination with a variety of electronic remote control units of the type commonly used to remotely operate televisions, radios, stereo systems, entertainment centers and the like, the holder comprising:
a first member, generally planar and shaped in the manner of an aircraft wing and defined by a left wing, a right wing end, a top surface and an underside;
a second member, being essentially a planar, right-triangular shape, defined as a vertical stabilizer, having a wide base and a narrower tip;
a means for perpendicularly attaching the base of said second member to the underside of said first member whereby the base of said second member is on a line equidistant between the left wing end and the right wing end of said first member;
the hook component of a hook-and-felt fastening mechanism attached to the top surface of said first member; and
a planar-shaped auxiliary packet, whereas one side of said auxiliary packet comprises the felt component of a hook-and-felt fastening mechanism, and the opposite side comprises an adhesive substance, said adhesive substance further protected by a peel-off material temporarily attached to said adhesive, whereby said peel-off material, when exposed, may be pressed against the bottom surface of a remote control apparatus, thereby providing secure attachment to said holder device, wherein
the conjoining of the first member and the second member, in combination with a remote control, form a cross-sectional profile serving to prevent the concealment of the holder device within folds, crevices, or junctions of cushions existing in furniture seats when the device is placed in the vicinity of said folds, crevices, or junctions.

3. A single-handed holder device constructed so as to prevent engorgement of the holder between the crevices, cushions, and/or folds of flexible furniture seats when the holder is placed in use in combination with a variety of electronic remote control units of the type commonly used to remotely operate televisions, radios, stereo systems, entertainment centers, and the like, the holder comprising:
a first member, generally planar and shaped in the manner of an aircraft wing and defined by a left wing, a right wing, a top side, an underside, and a hollow, attachment box enclosure integral to the underside of said first member, said attachment box enclosure further comprising an open groove along a line equidistant from the ends of each wing;
a second member, being essentially a planar, right-triangular shape, defined as a flanged vertical stabilizer, having a flange integrally attached orthogonally to the base of said second member thereto, wherein the thickness of the vertical stabilizer of said second member is of dimensions allowing snug insertion into the open groove of said first member and the thickness and dimensions of said flange correspond to the internal dimensions the attachment box enclosure, thereby permitting snug insertion into said box enclosure and
wherein
a means for attaching the bottom surface of a remote control apparatus to the top side of said first member; wherein
the conjoining of the first member and the second member, in combination with a remote control, form a cross-sectional profile serving to prevent the concealment of the holder device within folds, crevices, or junctions of cushions existing in furniture seats when the device placed in the vicinity of said folds, crevices, or junctions.

4. A holder device as in claim 1 or claim 3, wherein said means for attaching the bottom surface of a remote control apparatus to the top side of said first member comprises:
(a) the hook component of a hook-and-felt fastening mechanism attached to the topside of said first member; and
(b) a planar-shaped auxiliary packet, whereas one side of said auxiliary packet comprises the felt component of a hook-and-felt fastening mechanism, and the opposite side comprises an adhesive substance, said adhesive substance further protected by a peel-off material temporarily attached to said adhesive, whereby said peel-off material, when exposed, may be pressed against the bottom surface of said remote control apparatus, thereby providing secure attachment to said holder device.

5. A single-handed holder device as in either claim 1 or claim 2 wherein the means for perpendicularly attaching the base of said second member to the underside of said first member is by permanent bond-type glue.

6. A single-handed holder device as in either claim 1 or claim 2 wherein the means for perpendicularly attaching the base of said second member to the underside of said first member is by simultaneous injection molding of both members during fabrication of a unitary device.

7. A single-handed holder device as in either claim 1 or claim 2 wherein the means for perpendicularly attaching the base of said second member to the underside of said first member is by spot welding both members together during fabrication of the device.
